(19) United States
(12) Patent Application Publication
(10) Pub. No.: US 2025/0008231 A1
(43) Pub. Date: Jan. 2, 2025

(54) Camera and Real World Steradian Airspace Inertial System Apparatus and Method of making same

(71) Applicant: Louis Arthur Coffelt, JR., Perryville, MO (US)

(72) Inventor: Louis Arthur Coffelt, JR., Perryville, MO (US)

(21) Appl. No.: 18/344,002

(22) Filed: Jun. 29, 2023

(51) Int. Cl. H04N 23/95; G06T 1/00; G06T 7/70

(52) U.S. Cl. CPC H04N 23/95; G06T 1/0014; G06T 7/70

(57) ABSTRACT

The present invention comprises a camera and real world steradian airspace inertial system and method of making same. This is a real world frame of reference joined with a camera. The inertial system is formed of a matrix set of real world individual steradian airspace. e.g. the shape of a 3-dimensional solid angle. Each of these individual elements have a one to one correspondence with each digital image pixel. Therefore, each point of interest in a photograph can be assigned a real world location on the matrix of steradian airspace. This inertial system can be utilized to direct robot motion, or any other machine which depends on a frame of reference.

### BACKGROUND OF THE INVENTION

The present invention is related to the technology of real world intertial systems. For example, systems for controlling robot motion. In the field of robotics, lasers and point cloud data are utilized to position a robot. A computer controls the motion of the robot. One example of robot positioning is disclosed in European Patent No. CN114723920 (A)-2022 Jul. 8 Visual Positioning Method based on Point Cloud Map (EP 3920). The European patent EP 3920 discloses a system of robot positioning by utilization of lasers and point cloud data. Many publications disclose that laser systems have significant problems including scattering effect, which makes the corresponding point cloud data unreliable.

Digital cartesian coordinate systems in Computer Aided Design (CAD) is another example. In some cases, a 3-Dimensional (3D) scanner is utilized to generate point data of a real world object. Next, a person creates a 3D CAD model from the 3D scanned data. For example, a person creates a 3D electronic model which matches the 3D scanned photographs. For complex objects, this 3D scanned method is problematic. Multiple views must be utilized in order to construct the desired objects. Accuracy of the point data is also a significant problem.

US Patent Application Publication No. US2023/0066480 A1 (Weiss, et. al.) discloses problems with the state of the art 3D scanning. For example, scattering effect and correction methods.

### BRIEF SUMMARY OF THE INVENTION

The present invention is a camera and real world 3D steradian airspace inertial system apparatus. As used herein, the term “airspace” means a specific region of the atmosphere controlled by the steradian region boundaries of the present invention. A set of adjacent steradian solid angle airspace forms the inertial system. The steradian airspace is arranged in a matrix pattern of columns and rows. One significant aspect of the present invention is the steradian airspace has a concise size, and concise location relative to the camera. A significant utility of the present invention comprises deriving a location of objects in view of the camera, and deriving a specific size of objects in view of the camera. For example, directing robot motion, or measuring the size of an object.

The present invention also includes a method of making the novel camera and airspace inertial system apparatus. Only one 2D photograph is required to make this invention. For example, the camera steradian airspace inertial system apparatus can be created with steps comprising, as a brief general summary:

Creating only one 2D photograph of a real world cylinder.

Setting values of parameters. e.g. column and row values from the digital image of the photograph.

Executing a recursive test of specific real world steradian airspace inertial systems.

A significant utility of the present invention is, for example, not limited to robot set-up and operation. The method of making the novel inertial system provides that a robot can be set-up from a remote location. Furthermore, an object can be measured from a remote location with only one 2D photograph of the object.

### BRIEF DESCRIPTION OF THE SEVERAL VIEWS OF THE DRAWING

The present invention is described here with reference to the appended figures of the drawing where equivalent or corresponding parts are identified by the same reference character.

FIG. 1 is a perspective view of a camera (1), one individual real world 3D Steradian airspace (3), and electromagnetic radiation (EMR) sensor (10).

FIG. 2 is a side view of the camera (1), the steradian airspace (3), and the EMR sensor (10).

FIG. 3 is a front view of the camera (1), the steradian airspace (3), and the EMR sensor (10).

FIG. 4 is a top view of the camera (1), a real world matrix set of 3D steradian airspace (2), the EMR sensor (10), and an overall quantity width (W) of steradian airspace columns. e.g. the quantity is 13 columns in FIG. 4.

FIG. 5 is a top view of the camera (1), the real world matrix set of 3D steradian airspace (2), the EMR sensor (10), and an overall quantity height (H) of steradian airspace rows. e.g. the quantity is 13 rows in FIG. 5.

FIG. 6 is a perspective view of the camera (1), the real world matrix set of 3D steradian airspace (2), the EMR sensor (10), and a real world object (30) located in the set of steradian airspace (2). The individual steradian airspace boundaries are not shown in FIG. 6 for clarity.

FIG. 7 is a front view of a computer display (23), and a digital photograph (24) of the object (30). Also, showing a matrix set of the display (23) pixels arranged in a standard system of columns and rows. Also, showing the object's photographed profile (30P).

FIG. 8 is a front view of the computer display (23) and digital image (25). Image (25) is a CAD modified version of image (24), which superimposes an elliptic profile (AUE) and (ALE) on the profile (UE) (LE).

FIG. 9 is a side view of a first test case in a specific real world location. Also, showing a real world test point (31T) and real world test point 32T. These two center points (31T) and (32T) are axial end points of cylinder (30). A length of the axis (C) is equivalent to a length of the cylinder (30). Several steradian airspace boundaries are not shown for clarity.

FIG. 10 is a side view of a second test case in a specific real world location. Also, showing a real world test point (31T) and real world test point 32T. These two center points (31T) and (32T) are axial end points of cylinder (30). A length of the axis (C) is equivalent to a length of the cylinder (30). FIG. 9 and FIG. 10 show two distinctly different test cases while having several common parameters. Several steradian airspace boundaries are not shown for clarity.

FIG. 11 shows a perspective view of object (30) real world upper cylinder center point (31) and real world lower cylinder center point (32). Also, shows a test case solution upper circle center point (31L). Also, shows a test case solution lower circle center point (32L).

FIG. 12 shows a perspective view of the real world steradian airspace inertial system axis (i), (j), and (k). Also, shows parameters of the real world matrix set of steradian airspace (2) origin (20).

FIG. 13 is c++ computer source code for a function titled (FUNCTION STR).

FIG. 14 is c++ computer source code for a function titled (FUNCTION LAW COSINES).

FIG. 15 is c++ computer source code for a function titled (FUNCTION CASE TEST).

FIG. 16 is c++ computer source code for a function titled (FUNCTION ITERATE CYLINDER).

### BRIEF DESCRIPTION OF ITEMS IN FIGURES OF THE DRAWING

The following is a brief description of items in the figures of the drawing.

(i) i axis of the steradian airspace (2) inertial system.

(j) j axis of the steradian airspace (2) inertial system.

(k) k axis of the Steradian airspace inertial system.

(R) real world steradian radius.

(W) integer quantity of width of the steradian airspace inertial system columns.

(H) integer quantity of height of the steradian airspace inertial system rows.

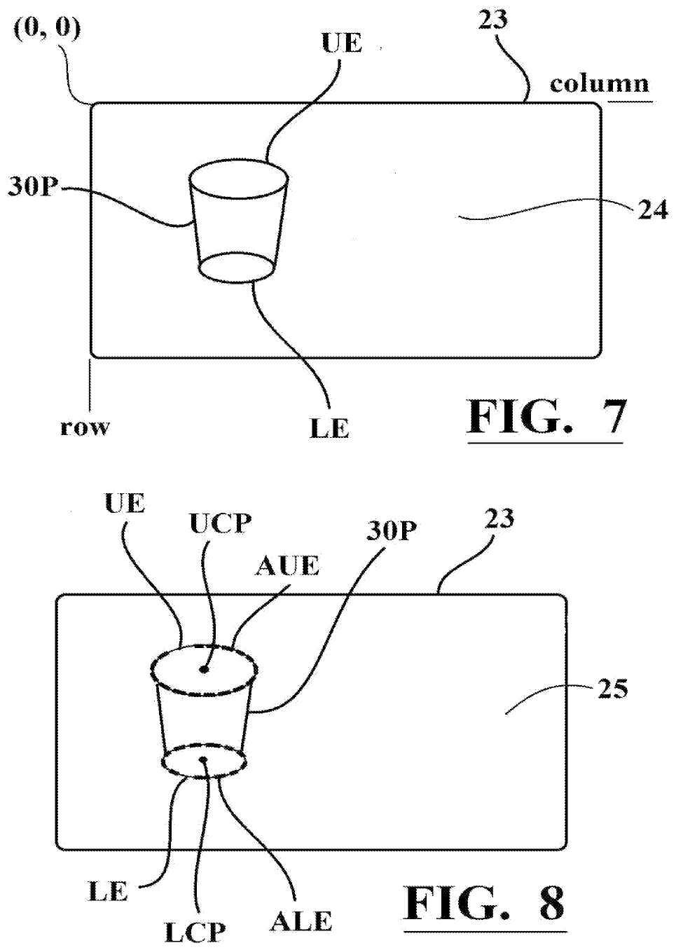

(column) (row) FIG. 7, FIG. 8, standard computer display image pixel matrix arrangement system.

(0, 0) (column) (row) FIG. 7, FIG. 8, digital image pixel origin zero, zero.

(1) camera.

(2) Steradian airspace inertial system.

(3) one individual steradian airspace.

(4) lower right boundary of the steradian airspace (3).

(5) upper right boundary of the steradian airspace (3).

(6) lower left boundary of the steradian airspace (3).

(7) upper left boundary of the steradian airspace (3).

(8) individual steradian airspace at steradian column 11, steradian row (H-1).

(9) individual steradian airspace at steradian column (W-1), steradian row 11.

(10) Electromagnetic Radiation (EMR) sensor matrix e.g. visible light, gamma rays, infrared radiation.

(11) one EMR sensor.

(12) vector connecting camera with EMR sensor (11).

(13) one point of object (30) located in one individual steradian airspace.

(15) upper right overall matrix (2) boundary at steradian airspace column 0, row 0.

(16) upper left overall matrix (2) boundary at steradian airspace column (W-1), row 0.

(17) lower right overall matrix (2) boundary at steradian airspace column 0, row (H-1)

(18) lower left overall matrix (2) boundary of the steradian airspace column (W-1), row (H-1).

(20) point location of steradian airspace orIgin column 0, row 0.

(21) point location of steradian airspace column (W-1), row (H-1).

(22) vector connecting object point (13) with the camera (1).

(23) computer display. e.g. monitor.

(24) digital image of the photograph of the object (30).

(25) modified image (24) of the object profile (30P).

(AUE) 2D CAD generated elliptic curve superimposed on the image (24) upper elliptic profile (UE) of object (30).

(ALE) 2D CAD generated elliptic curve superimposed on the image (24) lower elliptic profile (LE) of object (30).

(UCP) 2D CAD generated upper ellipse 2D center point of elliptic profile (UE).

(LCP) 2D CAD generated lower ellipse 2D center point of elliptic profile (LE).

(30) real world object in steradian airspace (2) e.g. cylinder.

(30P) digital profile in image (24) 2D profile of cylinder (30).

(31) real world cylinder upper center point of object (30). (32) real world cylinder lower center point of object (30).

(31S) real world location of steradian airspace point, corresponding to center point (31).

(32S) real world location of steradian airspace point, corresponding to center point (32).

(31T) real world test case location, corresponding to steradian center point (31S).

(32T) real world test case location, corresponding to steradian center point (32S).

(37) steradian airspace column origin angle, at column 0 relative to (i) axis.

(38) steradian airspace interior radial angle.

(39) steradian airspace row origin angle, at row 0 relative to (j) axis.

(31L) real world solution upper cylinder center point.

(32L) real world solution lower cylinder center point.

(31V) vector between point (31S) and camera (1) inertial system origin.

(32V) vector between point (32S) and camera (1) inertial system origin.

(A) test case vector having a length of a current distance for the test.

(B) test case vector having a derived length by Law of Cosines.

(C) constant axial length of object (30) e.g. axial length of the cylinder.

(str(584, 975)) steradian airspace five hundred eight fifth column, nine hundred seventy sixth row.

(str(395, 978)) steradian airspace three hundred ninety sixth column, nine hundred seventy ninth row.

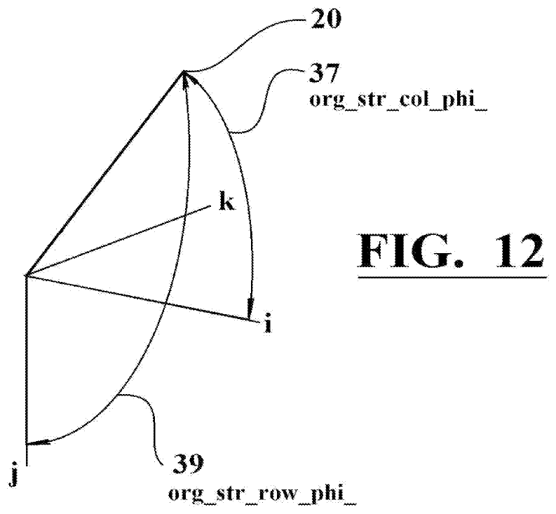

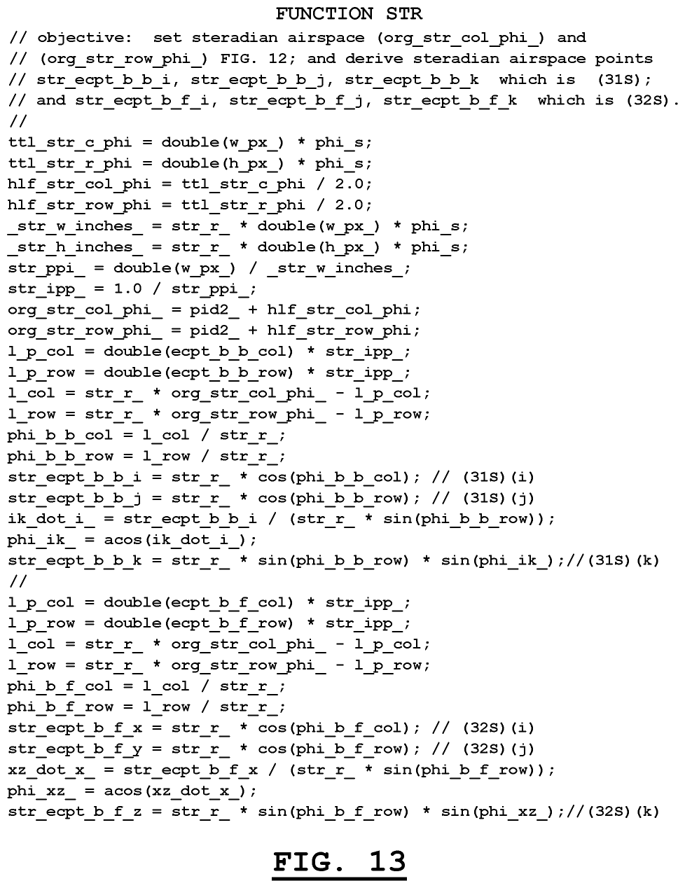

(org_str_col_phi_) steradian airspace column origin angle relative to (i) axis FIG. 12.

(org_str_row_phi_) steradian airspace row origin angle relative to (j) axis FIG. 12.

### DETAILED DESCRIPTION OF THE INVENTION

The present invention is related to the field of real world inertial systems. The present invention is a camera and a specific set of real world steradian airspace (e.g. solid angle). The combination of the camera and the steradian airspace form a useful real world inertial system. The following description comprise the best mode of operation of the present invention. The term “airspace” used herein means a specific region of the atmosphere controlled by the steradian airspace boundaries of the present invention.

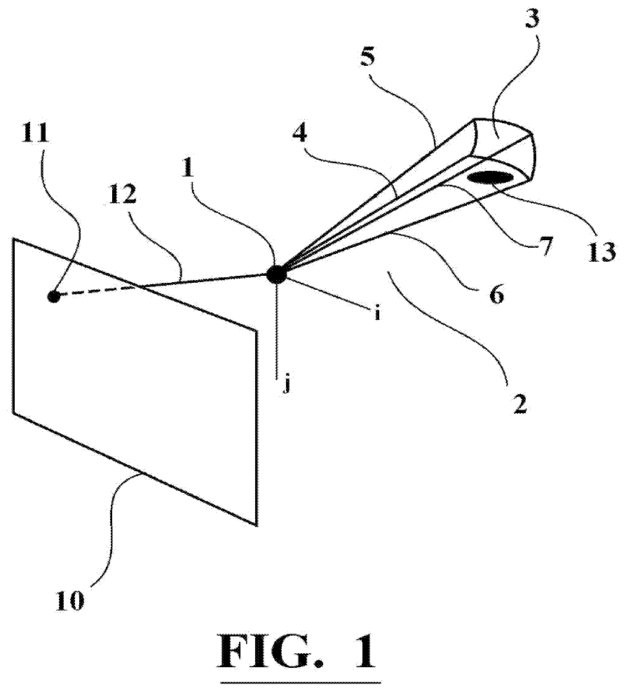

FIG. 1 shows a camera (1) located in a real world location. The camera (1) has a specific field of view. The field of view includes an approximate rectangular shape. The camera also includes an electromagnetic radiation (EMR) sensor matrix (10). For example, sensor matrix (10) may comprise a set of the quantity 12000000 sensors. e.g. quantity 4000 columns and quantity 3000 rows of sensors. The camera utilizes a 2D coordinate system for managing color of pixels in the EMR sensor matrix (10). For example, EMR sensor (11) is at column 20, row 18, and is assigned a color blue. Each sensor in the EMR matrix is assigned a specific color based on the radiation present at the corresponding sensor. The size and general structure of the EMR sensor matrix (10) has no effect on the present invention. EMR sensor (10) is described here to show a one to one correspondence between each pixel in a photograph and each distinct individual steradian airspace component of the present invention. The camera (1) may be a well known mobile cell phone camera manufactured in the year 2021. e.g. Motorola Moto G Power. The lens of this example camera is about 2 millimeters (mm) diameter. This camera also utilizes lens autofocus.

As used herein, an “inertial system” is a frame of reference within which bodies are not accelerated unless acted upon by external forces. The camera (1) and steradian airspace (2) form a real world inertial system. The camera (1) has a specific 2 dimensional (2D) relationship with a digital photograph produced by the camera. The photograph is formed of a 2D matrix set of pixels. The 2D matrix is formed of a specific quantity of columns, and a specific quantity of rows. For example, a photograph may have a quantity of 12000000 pixels, quantity 4000 columns, and quantity 3000 rows. Each pixel of the photograph has a one to one correspondence with each EMR sensor (10) element. Therefore, a 2D frame of reference inherently exists in the camera. One axis corresponding to the column pixels of the photograph. One axis corresponding to the row pixels of the photograph. This camera frame of reference forms a basis for the present invention steradian airspace frame of reference.

FIG. 1 also shows a real world overall steradian region of airspace (2) in the field of view of the camera. Boundaries of steradian airspace (2) are omitted in FIG. 1 for clarity. Boundaries of steradian airspace (2) are located at the boundaries of the field of view of the camera.

Steradian airspace (2) is formed of a matrix set of individual steradian airspace (3). Steradian airspace (3) is one element of the matrix set of steradian airspace (2). A real world object (30) is located in steradian airspace (2). FIG. 1 shows one point portion (13) of object (30) in steradian airspace (3). For example, the portion (13) is located at steradian column 20, steradian row 18; and this portion (13) causes EMR sensor (11) to assign the color blue to EMR sensor column 20, row 18; and the EMR sensor causes the digital photograph pixel at column 20, row 18 to be assigned the color blue. This one to one correspondence between the steradian regions of airspace and pixels in the photograph is utilized here to create the present invention. Steradian airspace column 20 and steradian airspace row 18 identifies one element of the matrix set of steradian airspace (2).

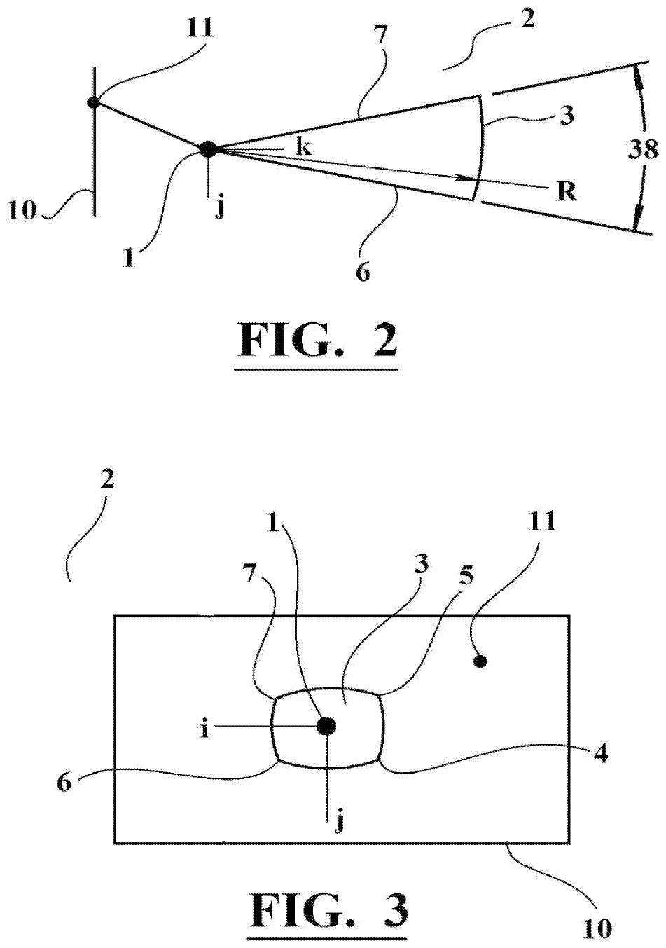

The one to one steradian airspace to photograph pixel relationship forms a basis for a real world 3 dimensional cartesian coordinate frame of reference (steradian coordinate system). Each individual steradian airspace corresponds to one specific photograph pixel. FIG. 1 shows an (i) and (j) axis of the steradian coordinate system. FIG. 2 shows a (k) axis of the steradian coordinate system. Each axis (i), (j), (k) has a specific real world location, and specific real world direction. An origin of the steradian airspace coordinate system is located at the camera (1) having coordinates (0, 0, 0). e.g. the camera (1) lens is at coordinates (0, 0, 0). The (i) and (j) steradian axes correspond with the 2D coordinate system of a digital photograph.

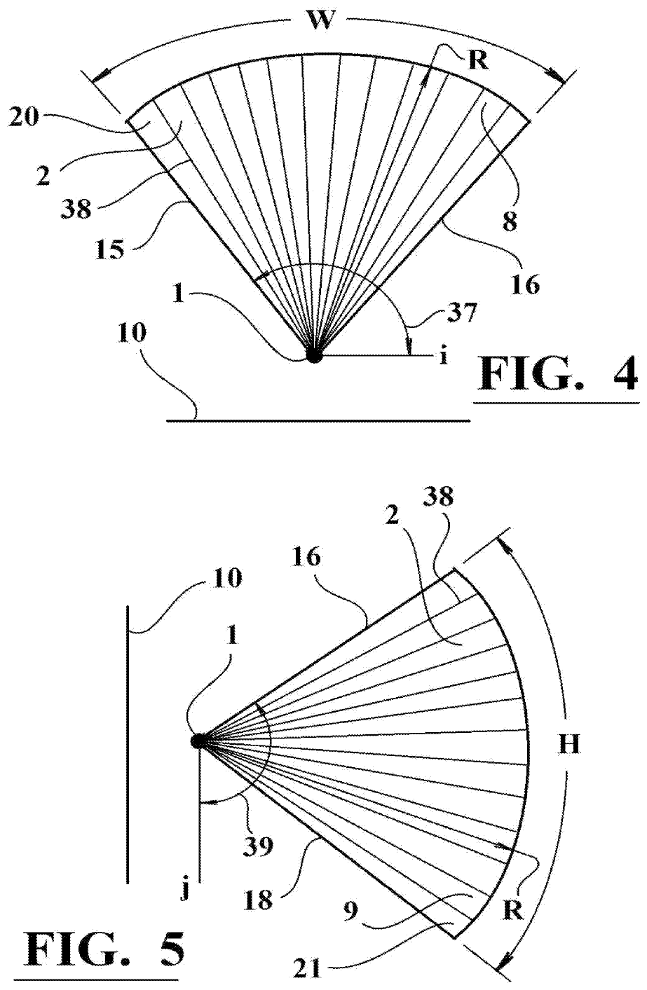

FIG. 2 shows a side view of individual steradian airspace (3). Also, showing an upper left boundary (7) of steradian airspace (3). Also showing a lower left boundary (6) of steradian airspace (3). FIG. 3 shows an upper right boundary (5) of steradian airspace (3). Also, shows a lower right boundary (4) of steradian airspace (3). FIG. 4 and FIG. 5 show a real world overall radius boundary (R) of the matrix set steradian airspace (2). The steradian radius (R) is a boundary of each individual steradian airspace in the matrix set. One method to create steradian airspace (3) includes creating electronic digital cartesian coordinates of corresponding points of boundaries (4), (5), (6), and (7). e.g. digital coordinates of a corresponding boundary cause the steradian airspace (3) to be a useful real world distinct region of controlled airspace.

FIG. 3 is a front view of steradian airspace (3) with the left steradian column boundary between (6) and (7). Also, showing the right steradian column boundary between (4) and (5). Also, showing an upper steradian row boundary between (5) and (7). Also, showing a lower steradian row boundary between (4) and (6). These steradian boundaries described here (4), (5), (6), (7), and (R) form the real world individual distinct steradian region of airspace (3). Each of these steradian airspace are created by specific data in a machine. e.g. a computer having coordinates of the boundaries, and size of the steradian radius (R). This data in the computer can be utilized to move a robot relative to these boundaries.

FIG. 4 is a top view of matrix set steradian airspace (2) formed of a width (W). In this example, (W) is the quantity 13 steradian columns. In this description of the present invention, standard column row, or coordinate i, j notation is utilized e.g. str(c, r) means the steradian airspace located at steradian column “c”, and steradian row “r” i.e. str(13, 22) is the steradian airspace located at steradian column 13, steradian row 22. This description utilizes a zero based index system. e.g. the first column is column 0, the second column is column 1, the third column is column 2, the first row is row 0, the second row is row 1, and the third row is row 2.

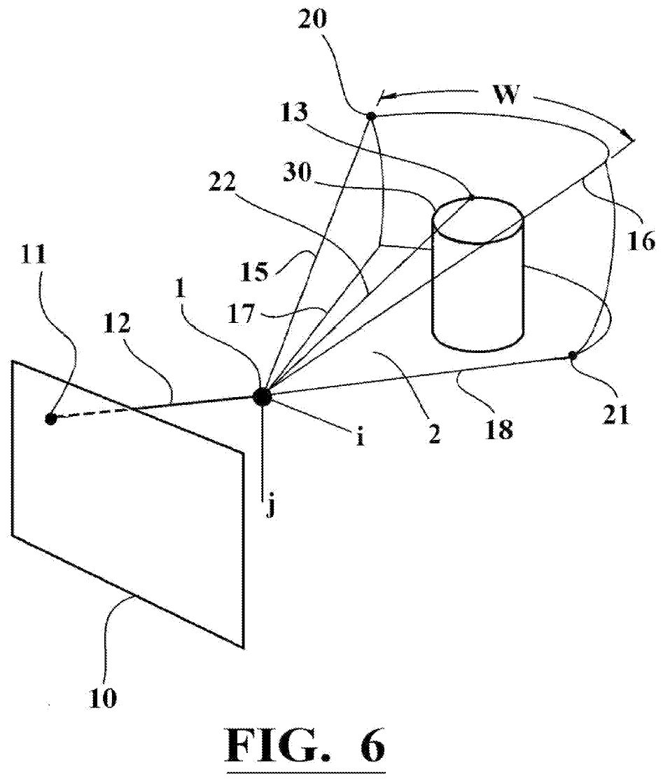

FIG. 4 shows steradian airspace origin (20) is located at steradian airspace str(0, 0). Steradian airspace (8) is located at str(11, 0). FIG. 6 shows the steradian airspace (2) has a right upper overall boundary (15). The steradian airspace (2) has a left upper overall boundary (16). The steradian airspace (2) has a right lower overall boundary (17). The steradian airspace (2) has a left lower overall boundary (18). FIG. 6 shows a right lower overall boundary (17). The overall boundaries of steradian airspace (2) are (15), (16), (17), and (18). Each individual steradian airspace on steradian column 0 is located at angle (37) from the (i) axis. For example, steradian airspace str(0, 0) has an angle (37) of 1.86 radians. str(0, 4) has an angle (37) of 1.86 radians, str(0, 8) has an angle (37) of 1.86 radians.

FIG. 4 also shows steradian airspace (20) has a specific interior radial angle size (38). For example, angle (38) may be 0.0002211 radians. In this example, an overall radial angle size on (W) is overall columns multiplied by the interior angle (38): 13.0*0.000211=0.0028743 radians. (W) is 13 columns, and the overall angle size on (W) is 0.0028743 radians. For example, (W) is 4000 columns, and the overall radial angle size on (W) is 0.8844 radians. The length of the spherical arc on (W) is derived by the well known formula of radius multiplied by angle size. For example, (R) is 48.0 inches; overall radial angle on (W) is 0.8844 radians: Each steradian row has the same quantity of columns, and the same overall radial angle size; therefore, each steradian row has an overall spherical arc length of 42.4512 inches on (W).

FIG. 5 is a side view of steradian airspace (2) formed of a height (H). In this example, (H) is the quantity 13 steradian rows. For example, for a corresponding digital image of size 4000 pixel width, and 3000 pixel height; (W) is 4000 steradian columns and (H) is 3000 steradian steradian rows.

FIG. 5 shows steradian airspace (21) is located at steradian airspace str(12, 12), and is the last element of the steradian airspace matrix. Steradian airspace (9) is located at str(12, 11). Boundary (16) has a specific angle (39) between the boundary and the (j) axis. Each individual steradian airspace on steradian row 0 is located at angle (39) from the (j) axis. For example, steradian airspace str(12,0) has an angle (39) of 1.86 radians; str(4, 0) has an angle (39) of 1.86 radians; str(8, 0) has an angle (39) of 1.86 radians. Each steradian column has the same quantity of rows. The overall spherical arc length derivation on (H) is similar to the previously described derivation on columns (W).

FIG. 5 also shows steradian airspace (21) has the specific interior radial angle size (38). The length of the overall spherical arc on (H) is derived by the well known formula of radius multiplied by angle size. For example, (R) is 48.0 inches; the overall radial angle size on (H) is 0.6633 radians: the spherical arc length on (H) is 48.0*0.6633=31.8384 inches.

Each individual steradian airspace has the same overall size. Therefore, each interior radial angle is the same. e.g. The angle between boundary (7) and (5) is 0.0002211 radians; the angle between boundary (6) and (4) is 0.0002211 radians; the angle between boundary (6) and (7) is 0.0002211 radians; the angle between boundary (4) and (5) is 0.0002211 radians. Each of the individual steradian airspace has the same interior boundary angle described here.

The matrix set of steradian airspace (2) form a useful frame of reference for manufacturing environments, including robotics, and CAD systems. For example, the present invention may be utilized to control a robot arm relative to the steradian airspace frame of reference. FIG. 6 is a perspective view of a real world cylinder (30) located in the steradian airspace (2).

FIG. 6 shows the point portion (13) of object (30) located in one individual specific steradian airspace. The boundaries of the individual steradian airspace are not shown for clarity. A real world vector (22) shows a connection between point (13) and the camera (1). Vector (22) can be created by a computer assigning specific coordinates of point (13) in the computer's memory. A robot can be programmed to move on the real world path of vector (22). One real world point (13) of the cylinder corresponds to EMR sensor (11). For example, point (13) is located in steradian airspace at str(8, 4). Therefore, the corresponding EMR sensor is EMR (8, 4), and the corresponding photograph image pixel is (8, 4).

Each one steradian airspace column row coordinates corresponds to the equivalent photograph digital image column row coordinates. This one to one correspondence forms a useful structure which provides utility of the present invention. Information in the digital image has a real world connection with the steradian airspace (2). For example, the coordinates of a robotic arm are known. The present invention provides the robot with a specific steradian airspace inertial system. The present invention also provides real world 3D coordinates of point (13). A robot can be programmed to move the arm to point (13), and execute the robotic process at point (13). Steradian airspace str(8, 4) is created by a computer assigning the airspace coordinates in the computer's memory. The computer saves real world coordinates in memory. e.g. an electronic digital computer. These real world steradian airspace coordinates saved in memory have utility. Therefore, the computer causes the specific steradian airspace to be created. For example, the computer is utilizing the specific steradian airspace boundaries. Therefore, the specific real world steradian airspace inertial system (2) exists.

### Method of Making the Present Invention

The present invention includes a method of making the camera and real world steradian airspace inertial system apparatus. The following steps show one of many possible methods of making the present invention. The claimed steps may be executed in any suitable sequence.

The present novel method comprises a real world system for creating the steradian airspace inertial system (2). An objective of this method is to attain an optimal size of the individual steradian airspace. Fundamental elements comprise a camera, a specific real world object, only one 2D photograph of the object, and a known approximate distance between the object and the camera. e.g. a distance of approximately 37.5 inches plus or minus 1.0 inch.

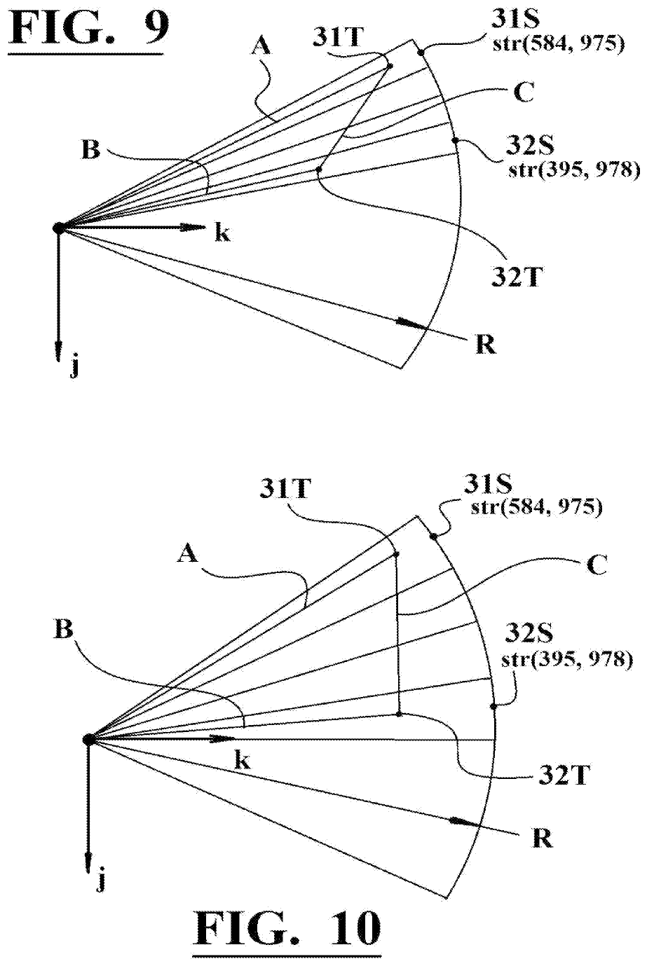

As used herein “str(c, r)” means a specific individual steradian airspace located at steradian column “c”, and steradian row “r”. e.g. In FIG. 9, str(584, 975) means the individual steradian airspace located at the five hundred eighty fifth steradian column, nine hundred seventy sixth steradian row. The index of the first element is zero in this zero based index system.

As used herein “img(c, r)” means a specific photograph's digital image pixel column “c”, and row “r”. e.g. img(584, 975) means the photograph's digital image pixel located at the five hundred eighty fifth column, nine hundred seventy sixth row, in the zero based index system.

As used herein “pi_” means program variable equal to the scalar value 3.141292653 radians.

As used herein “pid2_” means program variable equal to the scalar value pi/2.0=1.570796326 radians.

As used herein “vector” means two independent properties having magnitude and direction. The vector is both a real world element in the steradian airspace inertial system (2), and a digital vector.

As used herein “size” means real world physical magnitude.

As used herein “distance” means a real world physical magnitude of length.

As used herein “str_ppi_” means program variable for a quantity of steradian airspace per inch. e.g. FIG. 4 shows the quantity 13 steradian airspace columns having an overall spherical length on (W). e.g. (W) is the quantity 13; and the overall spherical arc length on (W) is 0.1444 inches. Therefore, str_ppi=13.0/0.1444; str_ppi=90.0277 steradian airspace per inch. str_ppi_is the same value for both the column (W) region and row (H) region. e.g. str_ppi=90.0277 on (W); and str_ppi=90.0277 on (H).

As used herein “str_ipp_” means program variable for inches per steradian airspace, which is the inverse of str_ppi_. str_ipp_=1.0/str_ppi_. e.g. str_ipp=1.0/90.0277; and str_ipp=0.01110769 inches per steradian airspace.

As used herein “phi_s” means program variable for individual steradian airspace interior angle (38).

As used herein “w_px_” means program variable for the overall steradian airspace columns on (W). (W) is equal to the photograph's digital image (24) pixel width.

As used herein “h_px_” means program variable for the overall steradian airspace rows on (H). (H) is equal to the photograph's digital image (24) pixel height.

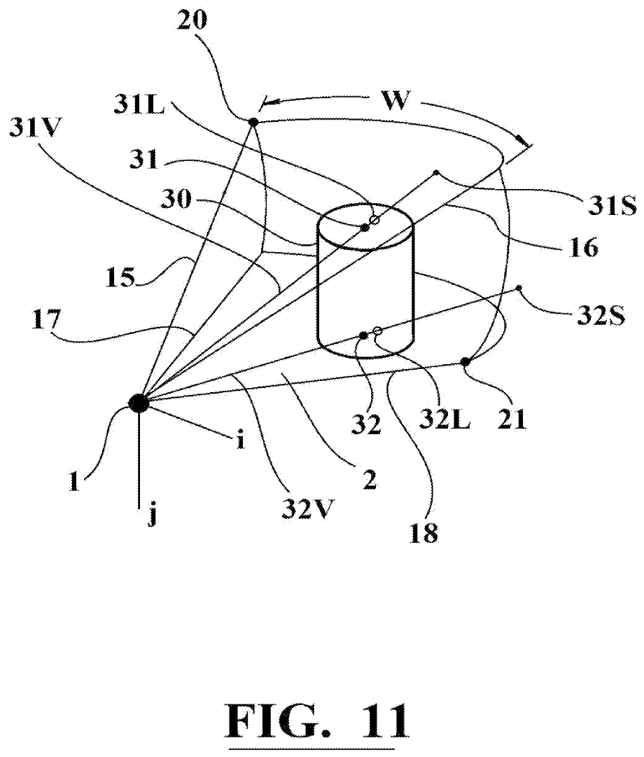

As used herein “ttl_str_c_phi” means program variable for overall steradian column angle. e.g. the overall angle on (W) in FIG. 4 and FIG. 11.

As used herein “ttl_str_r_phi” means program variable for overall steradian row angle. e.g. the overall angle on (H) in FIG. 5.

As used herein “hlf_str_col_phi” means program variable for half of the overall steradian column angle. e.g. half the overall angle on (W) in FIG. 4. e.g. ttl_str_c_phi/2.0

As used herein “hlf_str_row_phi” means program variable for half of the overall steradian row angle. e.g. half the overall angle on (H) in FIG. 5. e.g. ttl_str_r_phi/2.0

As used herein “str_r_” means program variable for steradian radius (R).

As used herein “_str_w_inches_” means program variable for overall spherical arc length on (W).

As used herein “str h inches” means program variable for overall spherical arc length on (H).

As used herein “org_str_col_phi_” means program variable for the steradian matrix column origin angle (37) relative to the (i) axis, in radians.

As used herein “org_str_row_phi_” means program variable for the steradian matrix row origin angle (39) relative to the j axis, in radians.

As used herein “ecpt_b_b_col” means program variable for an ellipse center point steradian airspace column. e.g. in FIG. 9, the ellipse center point (31) is located in steradian airspace column 584.

As used herein “ecpt_b_b_row” means program variable for an ellipse center point steradian airspace row. e.g. in FIG. 9, the ellipse center point (31) is located in steradian airspace row 975.

As used herein “l_p_col” means program variable for a specific spherical arc length on (W) relative to the steradian column origin (20). e.g. in FIG. 9, the spherical arc length on (W) at steradian row 975, between the origin (20) and (31S) at steradian column 584.

As used herein “l_p_row” means program variable for a specific spherical arc length on (H) relative to the steradian row origin (20). e.g. in FIG. 10, the spherical arc length on (H) at steradian column 584, between the origin (20) and (31S) at steradian row 975.

As used herein “l_col” means program variable for spherical arc length of a specific steradian point relative to the (i) axis. e.g. In FIG. 9, the spherical arc length between (31S) str(584, 975) and the (i) axis.

As used herein “l_row” means program variable for spherical arc length of a specific steradian point relative to the (j) axis. e.g. In FIG. 10, the spherical arc length between (31S) str(584, 975) and the (j) axis.

As used herein “phi_b_b_col” means program variable for angle between a specific steradian point and (i) axis. e.g. In FIG. 9, the angle between (31S) str(584, 975) and the (i) axis.

As used herein “phi_b_b_row” means program variable for angle between a specific steradian point and (j) axis. e.g. In FIG. 10, the angle between (31S) str(584, 975) and the (j) axis.

As used herein “phi_ik_” means program variable for angle between a specific point in the (i) (k) plane and the (i) axis. e.g. in FIG. 10, the angle between the (i) (k) coordinates of (31S) and the (i) axis.

As used herein “str_ecpt_b_b_i” means program variable for an (i) coordinate of a specific point at distance (R) from the origin (0, 0, 0). e.g. in FIG. 9, the (i) coordinate of (31S).

As used herein “str_ecpt_b_b_j” means program variable for an (j) coordinate of a specific point at distance (R) from the origin (0, 0, 0). e.g. in FIG. 9, the (j) coordinate of (31S).

As used herein “str_ecpt_b_b_k” means program variable for an (k) coordinate of a specific point at distance (R) from the origin (0, 0, 0). e.g. in FIG. 9, the (k) coordinate of (31S).

As used herein “e_b_b_dot_e_b_f” means a program variable for the vector dot product of vectors (A) and (B) in FIG. 9.

As used herein “_b_C” means program variable for an angle between vectors (A) and (B) shown in FIG. 9.

As used herein “curr_b_b_dist” means a program variable for a specific length of a vector. e.g length of vector (31V). e.g. length of vector (A) FIG. 9.

As used herein “root_b_f” means a program variable for a length of a vector. e.g. length of vector (32V). e.g. length of vector (B) in FIG. 9.

As used herein “cpt_b_b_x_” means a program variable for the (i) component of point (31T).

As used herein “cpt_b_b_y_” means a program variable for the (j) component of point (31T).

As used herein “cpt_b_b_z_” means a program variable for the (k) component of point (31T).

As used herein “cpt_b_f_x_” means a program variable for the (i) component of point (32T).

As used herein “cpt_b_f_y_” means a program variable for the (j) component of point (32T).

As used herein “cpt_b_f_z_” means a program variable for the (k) component of point (32T).

As used herein “coordinate transformation” means a change of coordinates in a first frame of reference to a second frame of reference. e.g. the coordinate transformation described in U.S. patent No. US20070232897A1 Method and system for performing coordinate transformation. The present invention may utilize any suitable coordinate transformation system.

As used herein “digital” means components of an electronic computer;

As used herein “digital representation” means an electronic component which corresponds to a real world component.

e.g. object (30) real world axial center point (31) is located at coordinates (4.9, 3.8, 2.8) relative to a known frame of reference; and a computer utilizes these coordinates for the utility of being the cylinder's real world axis center point (31); therefore these coordinates are a digital representation of the cylinder's real world center point.

A fundamental element of the present method is the one to one relationship between the individual steradian airspace and the photograph's digital image pixels. one specific steradian airspace corresponds to one specific image pixel. For example, str(0, 0) corresponds to img(0, 0); str(5, 3) corresponds to img(5, 3); str(4000, 3000) corresponds to img(4000, 3000). The steradian airspace column matches the image pixel column. The steradian row matches the image pixel row.

This one to one correspondence imposes a dependency on the test location (31T) and (32T) of an object in the steradian airspace inertial system. First, the image pixels impose a rule on the steradian airspace columns and rows. Next, the interior angle size (38) imposes a rule on the location of those steradian airspace columns and rows.

The location of a test point (31T) is directly proportional to the size of the interior angle (38). The dependency is shown in FIG. 9 and FIG. 10. For example, In FIG. 9 the interior angle (38) is 0.0002211 radians. In FIG. 10, the interior angle (38) is 0.0004528 radians. Test point (31T) is a distance (A) from the camera (1) origin as shown in FIG. 9. Test point (32T) is a distance (B) from the camera (1) origin.

FIG. 9 shows a portion of the matrix in the range of str(584, 975) through str(395, 978). Real world point (31S) is located at steradian airspace str(584, 975) in the zero based index system. Point (31S) is located at steradian airspace column 584, steradian airspace row 975, and is at distance (R) from the origin str(0, 0, 0).

In FIG. 9, For example, the steradian airspace interior angle (38) optimal size is 0.0002211 radians; and (R) is 48.0 inches; individual steradian spherical arc length is 48.0*0.0002211=0.0106128 inches per steradian. In this case the steradian density str_ppi_=1.0/0.0106128; str_ppi_=94.2258405 steradian airspace per inch. FIG. 11 shows this optimal interior angle (38) size provides points (31L) and (32L) are an approximate exact match of the real world points (31) and (32). An objective is that test points (31T) and (32T) have very close proximity with points (31) and (32) respectively.

In FIG. 10, For example, the steradian airspace interior angle (38) test case size is 0.0004528 radians; and (R) is 48.0 inches; individual steradian spherical arc length is 48.0*0.0004528=0.0217344 inches per steradian. In this case, FIG. 10, the steradian density str_ppi_=1.0/0.0217344; str_ppi_=46.010011 steradian airspace per inch. In this test case, points (31T) and (32T) do not have a suitable proximity to the real world points (31) and (32). The greater angle (38) size causes a greater unsuitable proximity.

FIG. 12 shows a location of steradian airspace (2) origin relative to the (i) and (j) axis.

The optimal size of interior angle (38) can be attained by developing solution points (31L) and (32L). These solution points closely match the presumed exact real world location of cylinder center points (31) and (32). e.g. there is an obvious dimensional tolerance in this system. For example, the digital image may have a specific resolution of 90 pixels per inch. Therefore, the exact real world location of (31) may be plus or minus 0.020 inches from the presumed location. The optimal size of interior angle (38) can be attained by finding points (31L) and (32L) which are nearest to points (30) and (32) respectively. An objective is to find the point (31L) which matches point (30); and find the point (32L) which matches point (32). This method is attempting to find points in the steradian airspace which match the real world points of the cylinder. Point (31L) is on vector (31V). Point (31S) is on vector (31V). Point (32L) is on vector (32V). Point (32S) is on vector (32V).

The present invention method of making comprises:

1.) Create a 2D photograph of a real world cylinder. The cylinder has a known diameter and length. e.g. The real world cylinder (30) has a diameter of 2.5 inches, and length of 9.27 inches. The cylinder length 9.27 corresponds to the vector (C) In FIG. 9. Create a 2D digital image (24) and (25) of the photograph.

2.) Create a domain of angular size (38) for each of the individual steradian airspace (3). e.g. the individual steradian airspace interior angle (38) is in the range of 0.0002011 rad<=phi_s<=0.0003322 phi_s is greater than or equal to 0.0002011 radians; and phi_s is less than or equal to 0.0003322 radians. Interior angle (38) is also referred to as (phi_s) herein.

3.) Assign a specific increment for the angular size. e.g. 3.70333e-6

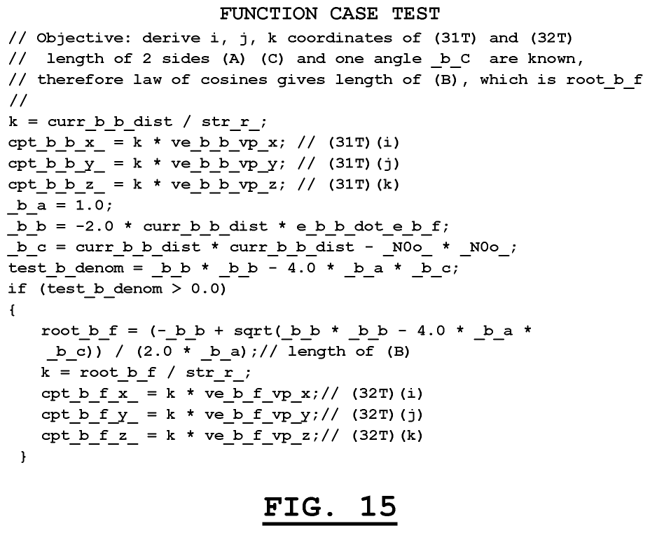

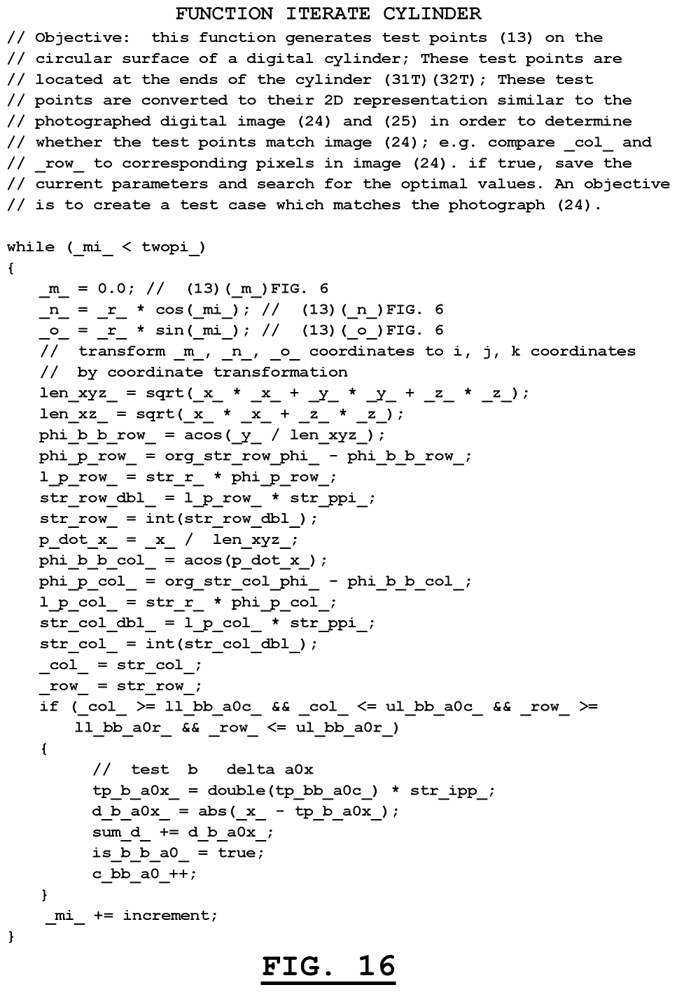

4.) Create a domain of distance for a specific point of object (30). e.g. the upper circular centerpoint (31) is about 58 inches from the camera (1) origin. Therefore, the range of distance may be 54.0<=distance<=60.0 The distance between the camera (1) and the object point (31) on vector (31V) is greater than or equal to 54.0 inches; and is less than or equal to 60.0 inches. Centerpoint (31) is on vector (31V). In FIG. 15, the program variable “curr_b_b_dist” represents vector (A); and “root_b_f” represents vector (B); and the constant length of the cylinder (30) is represented by vector (C). A length of root_b_f (B) is derived by the law of cosines.

5.) Assign a specific increment for the distance. e.g. 0.010 inches.

6.) Create a digital model of the object at the specific current distance and specific current angular size of the interior angle (38) (phi_s). e.g. create a 3D model of the cylinder in a computer program.

7.) Compare the digital model of step 6 to the presumed exact real world points (31) and (32). test the parameters of the 3D digital model relative to the 2D photographed image parameters; and save the current conditions of the angular size (38) and distance.

For a specific real world photograph, interior angle (38) has an unknown ideal value. Angle (38) is also referred to as (phi_s) in the description herein. The interior angle phi_s between (4) and (5) is equivalent to phi_s between (4) and (6); phi_s between (4) and (5) is equivalent to phi_s between (5) and (7); phi_s between (4) and (5) is equivalent to phi_s between (6) and (7). Each of these four interior angles (38) have the same value.

FIG. 7 shows a 2D image (24) on a computer display (23). The image (24) contains a 2D representation (30P) of the photographed cylinder (30). The image contains an upper 2D elliptic profile (UE). The image also contains a lower 2D elliptic profile (LE) of the cylinder (30).

In a photo editing computer program, edit the image (24) by adding ellipse (AUE) and ellipse (ALE), which match the photographed image profile (UE) and (LE). This provides a method to derive a 2D center point (UCP) and (LCP) of the ellipse (UE) and ellipse (LE). For example, center point (UE) has 2D coordinates of img(584, 975). Center point (LE) has 2D coordinates of img(395, 978) as shown in FIG. 9. These ellipse 2D center points (UCP) (LCP) can be derived from the standard mathematical equation of an ellipse.

The following c++ code is described in the following to show an example of fundamental steps to attain the optimal interior angle size (38).

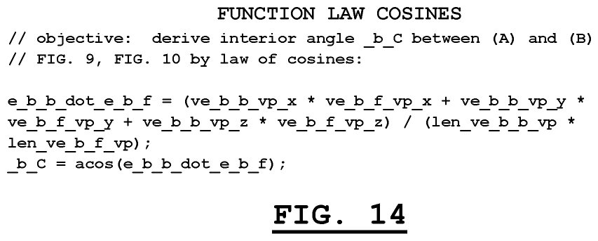

One method to create the optimal size interior angle (38) is to create a series of test cases. For example, in a computer program, execute a recursive nested loop. The loops create and test each possible case. e.g. an outside loop iterates on various values of the angle size (38); and the nested loop iterates on the distance between the camera and the object (30) center point (31). Each increment in the angle size loop restarts the nested iteration of the distance. Therefore, all combinations of distance and size are tested. A brief description of the recursive loops is as follows:
(a) assign start value of phi_s. e.g. start phi_s is 0.0002211 radians.
(b) assign an end value of phi_s. e.g. end phi_s is 0.0003358 radians.
(c) assign start and end value of distance. e.g. start distance is 36.5 inches; end distance is 38.5 inches.
(d) start of outer loop
(e) Execute FUNCTION STR, FIG. 13.
(f) reset current distance (curr_b_b_dist) is equal to start distance.
(g) start nested loop
(h) Execute FUNCTION LAW COSINES, FIG. 14.
(i) Execute FUNCTION CASE TEST, FIG. 15.
(j) Execute FUNCTION ITERATE CYLINDER, FIG. 16.
(k) increment (curr_b_b_dist), (A), FIG. 9.
(l) if (curr_b_b_dist) is greater than the end distance: break nested loop; increment phi_s and continue at (e)
(m) if (curr_b_b_dist) is less than the end distance: continue at (g).

The description herein sets forth specific examples of the present invention. Many variations of the present invention are possible. Therefore, limitations should only be imposed as those set forth in the appended claims.

1. A camera and real world steradian airspace inertial system apparatus comprising:
a camera;
a specific real world location of the camera;
a real world matrix set of individual steradian airspace;
the set is at the specific real world location;
a real world overall radius boundary of the set;
a real world left upper overall boundary of the set;
a real world left lower overall boundary of the set;
a real world right upper overall boundary of the set;
a real world right lower overall boundary of the set;
a real world overall radial angle size on columns of the set;
a real world overall radial angle size on rows of the set;
a real world individual steradian airspace upper left boundary in the set;
a real world individual steradian airspace lower left boundary in the set;
a real world individual steradian airspace upper right boundary in the set;
a real world individual steradian airspace lower right boundary in the set;
a real world individual steradian airspace interior radial angle size in the set;
a real world steradian airspace inertial system of the set.

2. The camera and real world steradian airspace inertial system apparatus according to claim 1 furthermore comprising;
a digital representation of the location;
a digital representation of the overall radius boundary;
a digital representation of the left upper overall boundary;
a digital representation of the left lower overall boundary;
a digital representation of the right upper overall boundary;
a digital representation of the right lower overall boundary;
a digital representation of the overall radial angle size on columns;
a digital representation of the overall radial angle size on rows;
a digital representation of the individual interior radial angle size.

3. A method of making a camera and real world steradian airspace inertial system apparatus comprising the steps of:
a camera;
a specific real world location of the camera;
a real world object;
the camera creating a 2D photograph of the object;
creating a digital representation of a matrix set of individual steradian airspace;
creating a digital representation of the real world location;
creating a digital representation of a steradian airspace overall radius boundary of the set;
creating a digital representation of a specific individual steradian airspace in the set;
the specific individual airspace column matches the object's photographed digital image corresponding column;
the specific individual airspace row matches the object's photographed digital image corresponding row;
(a) creating a digital representation of an individual steradian airspace interior radial angle size;
(b) a real world left upper overall boundary of the set created from the digital representation;
(c) a real world left lower overall boundary of the set created from the digital representation;
(d) a real world right upper overall boundary of the set created from the digital representation;
(e) a real world right lower overall boundary of the set created from the digital representation;
(f) a real world individual steradian airspace upper left boundary in the set created from the digital representation;
(g) a real world individual steradian airspace lower left boundary in the set created from the digital representation;
(h) a real world individual steradian airspace upper right boundary in the set created from the digital representation;
(i) a real world individual steradian airspace lower right boundary in the set created from the digital representation;
(j) a real world matrix set of individual steradian airspace created from the digital representation;
(k) a real world test location of the object created from the digital representation;
(l) a recursive iteration of steps (a), (b), (c), (d), (e), (f), (g), (h), (i), (j), (k);
a real world steradian airspace inertial system created from these digital representations.

4. The method of making a camera and real world steradian airspace inertial system apparatus according to claim 3 furthermore comprising:
the object is a cylinder;
a digital matrix set of pixels of the photograph;
a specific pixel of the set corresponding to the cylinder;
a real world individual steradian airspace matches the specific pixel.
